(19) United States
(12) Patent Application Publication
(10) Pub. No.: US 2019/0050367 A1
(43) Pub. Date: Feb. 14, 2019

(54) TECHNOLOGIES FOR SELECTIVELY EXCLUDING USER DATA FROM MACHINE LEARNING OPERATIONS

(71) Applicant: Intel Corporation, Santa Clara, CA (US)

(72) Inventors: Karla Saur, Portland, OR (US); Casey Baron, Chandler, AZ (US); Hebatallah Saadeldeen, San Jose, CA (US); Annie Foong, Aloha, OR (US); Sherry Chang, El Dorado Hills, CA (US)

(21) Appl. No.: 16/143,814

(22) Filed: Sep. 27, 2018

(51) Int. Cl. G06F 15/18; G06F 21/31; H04L 9/06; G06F 17/30

(52) U.S. Cl. CPC G06F 15/18; G06F 21/31; H04L 2209/38; G06F 17/30946; H04L 9/0637

(57) ABSTRACT

Technologies for selectively excluding user data from machine learning operations include a compute device. The compute device includes circuitry configured to receive user data that defines content associated with a user and write the user data as one or more immutable entries in a data structure. The circuitry is also configured to receive a request to selectively exclude, from an analysis of the user data in the data structure, a portion of the user data that meets a set of criteria. Additionally, the circuitry is configured to analyze the user data in the data structure while excluding, from the analysis, user data that satisfies the set of criteria.

### BACKGROUND

Many companies receive data (e.g., user data) that describes the interests, preferences, and activities of their users and, using that data, perform machine learning operations to provide items, such as information, products, or services, that their users will likely be interested in. If data regarding a user quickly changes, the machine learning operations may be slow to adapt, as the data upon which the machine learning operations rely is primary populated with outdated information about the user. As such, to address this issue and/or to respond to requests to delete user data in jurisdictions that provide users with a right to be forgotten, human operators of such systems may perform a time-intensive manual deletion of user data. Further, in systems in which the user data is resistant to deletion (e.g., the data is distributed across multiple systems in a distributed ledger), the process of correcting the determinations made by the machine learning operations is even more difficult or impossible.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified diagram of at least one embodiment of a system for selectively excluding user data from machine learning operations;

FIG. 2 is a simplified block diagram of at least one embodiment of a compute device included in the system of FIG. 1;

FIGS. 3-6 are a simplified block diagram of at least one embodiment of a method for selectively excluding user data from machine learning operations that may be performed by a compute device of the system of FIG. 1; and

FIG. 7 is a simplified diagram of at least one embodiment of a data structure for storing user data that may be utilized by the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

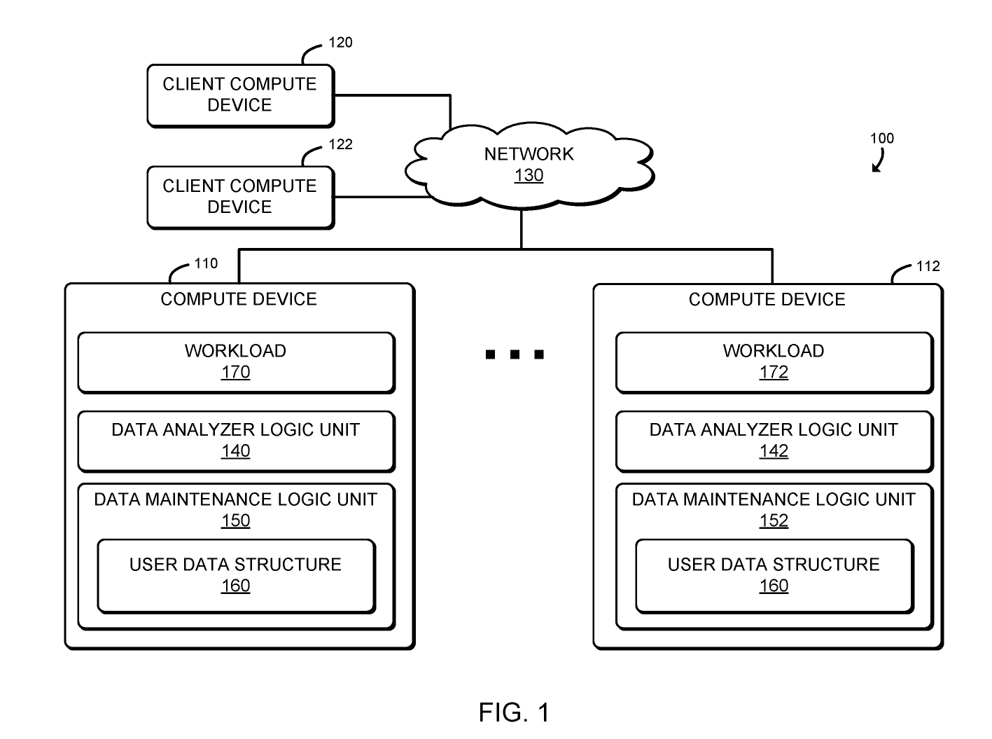

Referring now to FIG. 1, a system 100 for selectively excluding user data from machine learning operations includes a set of compute devices 110, 112 (e.g., compute devices that provide services, such as movie streaming, music streaming, product ordering, social media, etc. on behalf of users) in communication with a set of client compute devices 120, 122 (e.g., compute devices operated by users of the services) through a network 130. The compute devices 110, 112, in the illustrative embodiment, are located in one or more data centers (e.g., cloud data center(s)) and execute workloads 170, 172 (e.g., sets of operations to anticipate interests of the users and provide corresponding content, such as movies, music, and/or information about products, to the users). In the illustrative embodiment, the compute devices 110, 112 each include a data analyzer logic unit 140, 142 and a data maintenance logic unit 150, 152. Each data analyzer logic unit 140, 142 may be embodied as any device or circuitry (e.g., a co-processor, a field programmable gate array (FPGA), an application specific integrated circuit (ASIC), etc.) or software configured to perform machine learning operations on user data pertaining to learn about a user and make corresponding determinations to customize the services provided to each user (e.g., to select movies, music, and/or advertisements to provide to a user). In doing so, and as described in more detail herein, each data analyzer logic unit 140, 142 is configured to selectively exclude from the machine learning operations (e.g., ignore) user data that is associated with a set of analysis exclusion data (e.g., data defining a set of criteria for user data that should be ignored when performing machine learning operations).

Further, in the illustrative embodiment, each compute device 110, 112 includes a data maintenance logic unit 150, 152 which may be embodied as any device or circuitry (a co-processor, an FPGA, an ASIC, etc.) or software configured to iteratively add data to a user data structure 160 as the user data is provided by the client compute devices 120, 122 (e.g., through activities, such as selecting movies or music, purchasing of products, providing content such as images, audio, videos, etc. associated with the users while using the services provided by the compute devices 110, 112). The data maintenance logic units 150, 152 may also respond to requests from users (e.g., from the client compute devices 120, 122) to forget (e.g., selectively exclude) user data satisfying criteria defined in the request. In the illustrative embodiment, the data maintenance units 150, 152 verify that the requesting user actually has authorization to have the data excluded (e.g., by verifying that the requesting user is the owner of the user data that is to be excluded), as described in more detail herein. The user data structure 160, in the illustrative embodiment, is a distributed ledger (e.g., a data structure, such as a database, that is shared and synchronized across a set of compute devices) in which entries of user data in the distributed ledger are immutable (e.g., not modifiable after they have been added to the distributed ledger). As such, unlike typical systems in which user data is difficult or impossible to exclude from machine learning operations once the user data has been obtained, the system 100 is able to efficiently ignore, upon request, user data matching criteria specified by an owner (e.g., the originator) of that user data.

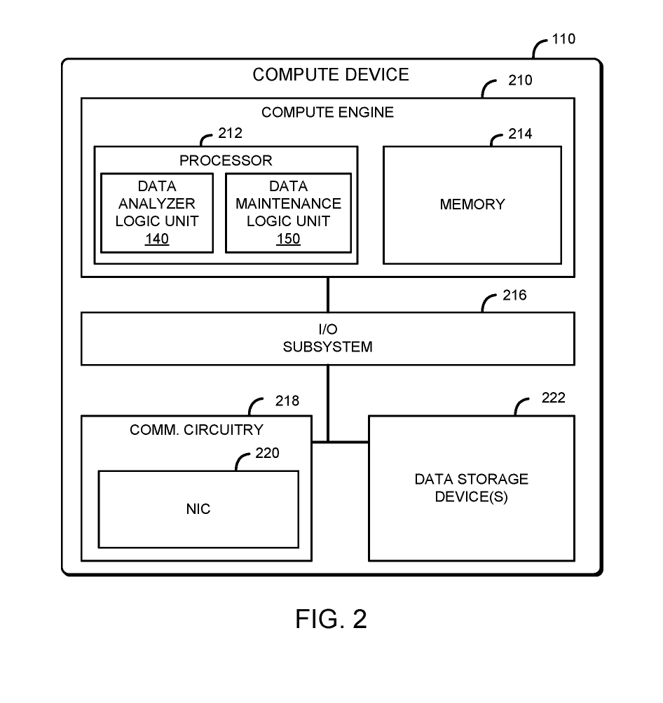

Referring now to FIG. 2, the illustrative compute device 110 includes a compute engine (also referred to herein as “compute engine circuitry”) 210, an input/output (I/O) subsystem 216, communication circuitry 218, and one or more data storage devices 222. Of course, in other embodiments, the compute device 110 may include other or additional components, such as those commonly found in a computer (e.g., a display, peripheral devices, etc.). Additionally, in some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. In the illustrative embodiment, the compute engine 210 includes or is embodied as a processor 212 and a memory 214. The processor 212 may be embodied as any type of processor capable of performing the functions described herein. For example, the processor 212 may be embodied as a multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein. In the illustrative embodiment, the processor 212 includes the data analyzer logic unit 140 and the data maintenance logic unit 150, both of which are described above with reference to FIG. 1. In other embodiments, the data analyzer logic unit 140 and/or the data maintenance logic unit 150 are located in elsewhere in the compute device 110 (e.g., not included in the processor 212).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as dynamic random access memory (DRAM) or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

In one embodiment, the memory device is a block addressable memory device, such as those based on NAND or NOR technologies. A memory device may also include a three dimensional crosspoint memory device (e.g., Intel 3D XPoint™ memory), or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product.

In some embodiments, 3D crosspoint memory (e.g., Intel 3D XPoint™ memory) may comprise a transistor-less stackable cross point architecture in which memory cells sit at the intersection of word lines and bit lines and are individually addressable and in which bit storage is based on a change in bulk resistance. In some embodiments, all or a portion of the main memory 214 may be integrated into the processor 212. In operation, the main memory 214 may store various software and data used during operation such as applications, libraries, and drivers.

The compute engine 210 is communicatively coupled to other components of the compute device 110 via the I/O subsystem 216, which may be embodied as circuitry and/or components to facilitate input/output operations with the compute engine 210 (e.g., with the processor 212 and/or the main memory 214) and other components of the compute device 110. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the compute device 110, into the compute engine 210.

The communication circuitry 218 may be embodied as any communication circuit, device, or collection thereof, capable of enabling communications over the network 130 between the compute device 110 and another compute device (e.g., the compute device 112, the client compute devices 120, 122, etc.). The communication circuitry 218 may be configured to use any one or more communication technology (e.g., wired or wireless communications) and associated protocols (e.g., Ethernet, Bluetooth®, Wi-Fi®, WiMAX, etc.) to effect such communication.

The illustrative communication circuitry 218 includes a network interface controller (NIC) 220, which may also be referred to as a host fabric interface (HFI). The NIC 220 may be embodied as one or more add-in-boards, daughter cards, network interface cards, controller chips, chipsets, or other devices that may be used by the compute device 110 to connect with another compute device (e.g., the compute device 112, the client compute devices 120, 122, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. In such embodiments, the local processor of the NIC 220 may be capable of performing one or more of the functions of the compute engine 210 described herein. Additionally or alternatively, in such embodiments, the local memory of the NIC 220 may be integrated into one or more components of the compute device 110 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

The compute device 112 and client compute devices 120, 122 may have components similar to those described in FIG. 2 with reference to the compute device 110. The description of those components of the compute device 110 is equally applicable to the description of components of the compute device 112 and the client compute devices 120, 122, with the exception that, in some embodiments, the client compute devices 120, 122 do not include the data analyzer logic unit 140 or the data maintenance logic unit 150. Further, it should be appreciated that any of the compute devices 110, 112 and the client compute devices 120, 122 may include other components, sub-components, and devices commonly found in a computing device, which are not discussed above in reference to the compute device 110 and not discussed herein for clarity of the description.

As described above, the compute devices 110, 112 and the client compute devices 120, 122 are illustratively in communication via the network 130, which may be embodied as any type of wired or wireless communication network, including global networks (e.g., the Internet), local area networks (LANs) or wide area networks (WANs), cellular networks (e.g., Global System for Mobile Communications (GSM), 3G, Long Term Evolution (LTE), Worldwide Interoperability for Microwave Access (WiMAX), etc.), a radio area network (RAN), digital subscriber line (DSL) networks, cable networks (e.g., coaxial networks, fiber networks, etc.), or any combination thereof.

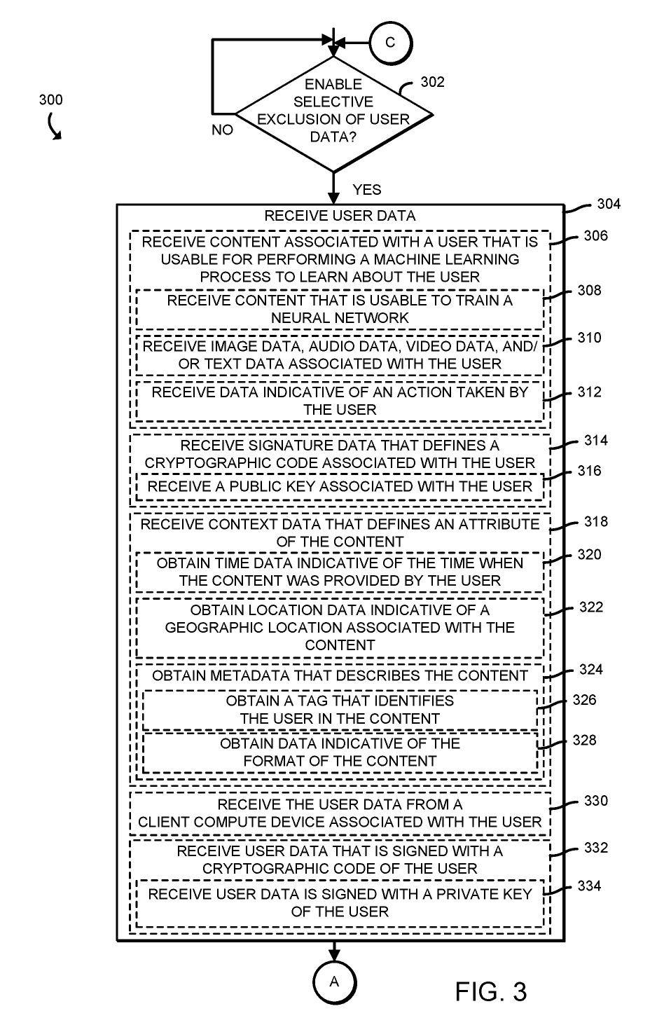

Referring now to FIG. 3, the compute device 110, in operation, may execute a method 300 for selectively excluding user data from machine learning operations. The method 300 begins with block 302, in which the compute device 110 determines whether to enable selective exclusion of user data. In making the determination, the compute device 110 may determine whether the compute device 110 is equipped with the data analyzer logic unit 140 and the data maintenance logic unit 150. Additionally or alternatively, the compute device 110 may determine whether a configuration setting (e.g., in a configuration file stored in the data storage device 222) indicates to enable selective exclusion of user data. In other embodiments, the compute device 110 may make the determination based on other or additional factors. Regardless, in response to a determination to enable selective exclusion of user data, the method 300 advances to block 304 in which the compute device 110 may receive user data (e.g., from a client compute device 120, 122). In doing so, in the illustrative embodiment, the compute device 110 receives content that is associated with a user and is usable for performing a machine learning process to learn about the user (e.g., products purchased by the user, movies viewed by the user, etc.), as indicated in block 306.

As indicated in block 308, in the illustrative embodiment, the received content may be used to train a neural network (e.g., a set of processes associated with nodes in a network to recognize underlying relationships in a set of data), such as to identify preferences of the user, to predict future actions of the user based on a pattern of previous user actions indicated in the user data, etc. In receiving the content, and as indicated in block 310, the compute device 110 may receive image data (e.g., images that have been sent by the user to the compute device 110, such as an update to a profile of the user in a social network operated by the compute device 110), audio data, video data, and/or text data (e.g., comments made by the user about a product, a response written by the user to information shared on a social network, etc.) associated with the user. As indicated in block 312, the compute device 110 may receive data indicative of an action taken by the user (e.g., that the user purchased a particular product, that the user viewed a particular movie, etc.).

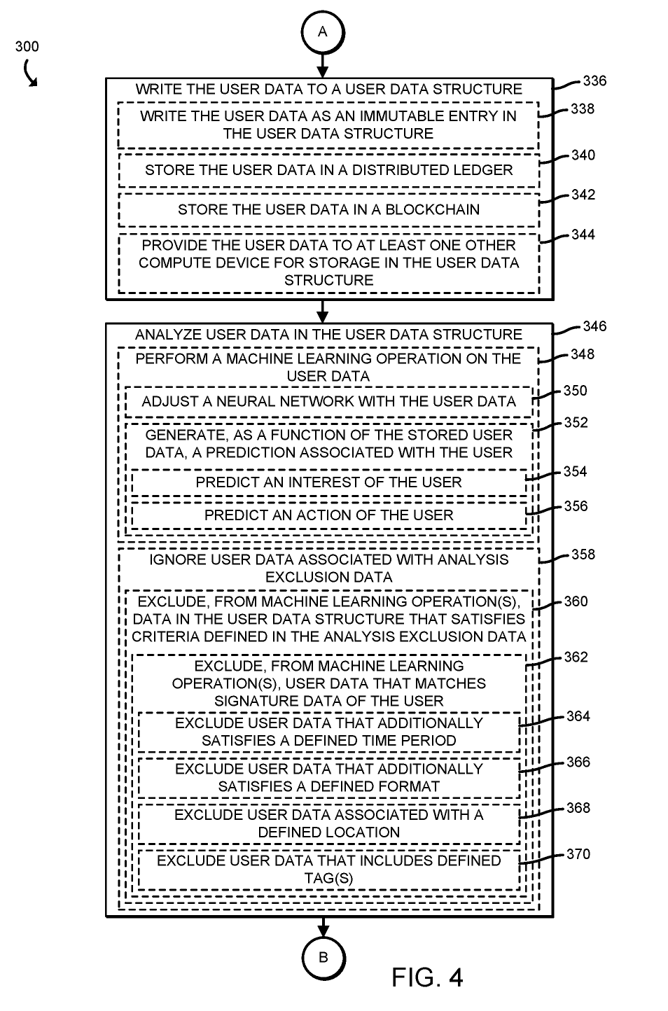

In the illustrative embodiment, the compute device 110 also receives signature data that defines a cryptographic code associated with the user, as indicated in block 314. For example, and as indicated in block 316, the compute device 110 may receive a cryptographic key (e.g., a public key of a public-private key pair) associated with the user. As indicated in block 318, the compute device 110 may receive context data, which may be embodied as any data that defines an attribute of the content. For example, the compute device 110 may obtain time data (e.g., a timestamp) indicative of the time when the content was provided by the user (e.g., when the content was received by the compute device 110 in block 306), as indicated in block 320. Additionally or alternatively, the compute device 110 may obtain location data indicative of a geographic location (e.g., a street address, a set of geographic coordinates, etc.) associated with the content, as indicated in block 322. As indicated in block 324, the compute device 110 may obtain metadata which may be embodied as any data that describes the content. For example, and as indicated in block 326, the compute device 110 may obtain a tag that identifies the user in the content (e.g., a set of text that identifies the user, such as the user's name, and a set of coordinates identifying the location of the user in an image). The compute device 110 may also receive data that indicates the format of the content (e.g., that the content is an image, audio, video, text, etc.), as indicated in block 328. As indicated in block 330, and as stated above, the compute device 110 may receive the user data from a client compute device (e.g., the client compute device 120) associated with the user. Further, in the illustrative embodiment, and as indicated in blocks 332 and 334, the user data received by the compute device 110 is signed with a cryptographic code (e.g., the private key) of the user. For example, the client compute device 120 may produce a one-way hash of the user data, encrypt the one-way hash using the user's private key, and append the encrypted one-way hash to the user data. Subsequently, the method 300 advances to block 336 of FIG. 4, in which the compute device 110 writes the user data to a user data structure (e.g., the user data structure 160).

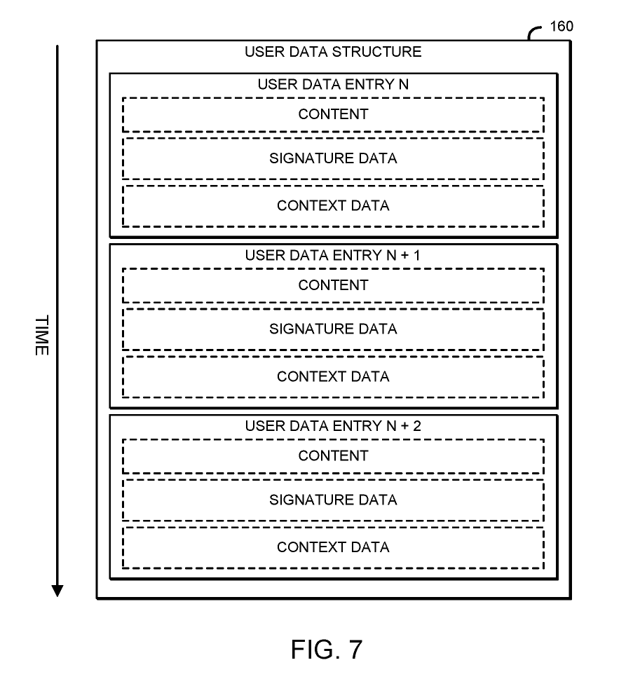

Referring now to FIG. 4, in writing the user data to the user data structure 160, the compute device 110 may write the user data as an immutable entry in the user data structure 160 (e.g., the entry cannot be modified or deleted), as indicated in block 338. In the illustrative embodiment, and as indicated in block 340, the compute device 110 stores the user data in a distributed ledger (e.g., the user data structure 160 is a distributed ledger). Further, and as indicated in block 342, the distributed ledger may be a blockchain (e.g., a growing list of records, referred to as blocks, which are linked using cryptography, such that each block includes a cryptographic hash of the previous block, a timestamp, and transaction data which may be represented as a merkle tree root hash). A simplified diagram of an embodiment of the user data structure 160 growing over time is shown in FIG. 7. As indicated in block 344, the compute device 110 may provide the user data to at least one other compute device (e.g., the compute device 112) for storage in the user data structure (e.g., in a copy of the data structure 160 maintained by the compute device 112). In the illustrative embodiment, the compute device 110 also analyzes user data in the user data structure 160, as indicated in block 346. In doing so, the compute device 110 may perform one or more machine learning operations on the user data, as indicated in block 348. For example, and as indicated in block 350, the compute device 110 may adjust a neural network based on the user data (e.g., using the user data as feedback to selectively reinforce or deemphasize the contribution of one or more nodes in the neural network to future determinations made by the neural network). As indicated in block 352, the compute device 110 may generate, as a function of the stored user data, a prediction associated with the user. For example, the compute device 110 may predict a preference of the user (e.g., for a particular type of movie), as indicated in block 354, and/or may predict an action of the user (e.g., to purchase a particular product), as indicated in block 356.

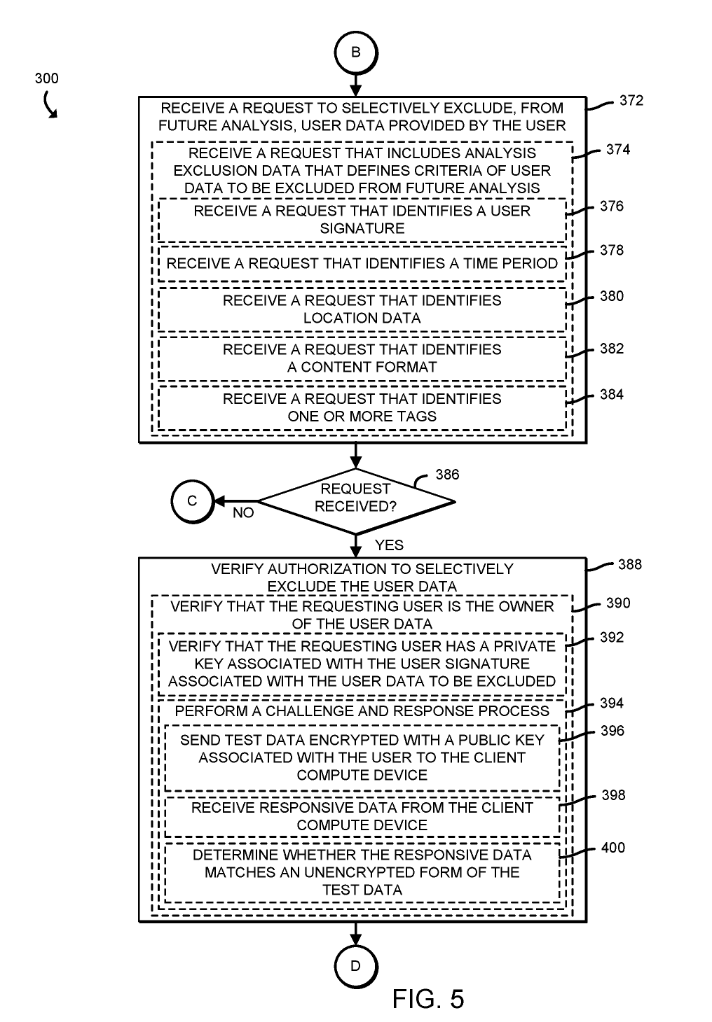

As indicated in block 358, in analyzing the user data in the user data structure, the compute device 110 may ignore user data associated with analysis exclusion data (e.g., which may be defined in a request from a client compute device 120, 122 as explained in more detail herein). In doing so, the compute device 110 may exclude, from machine learning operations, data in the user data structure that satisfies criteria that is defined in the analysis exclusion data, as indicated in block 360. For example, and as indicated in block 362, the compute device 110 may exclude, from the machine learning operations, user data that matches signature data of the user (e.g., the public key of the user, from block 316). Additionally, the compute device 110 may match the user data against further criteria, such as a time period defined in the analysis exclusion data (e.g., a time before which all data is to be excluded, a time after which all data is to be excluded, a time period within which all data is to be excluded, etc.), as indicated in block 364. Additionally or alternatively, the compute device 110 may exclude user data that satisfies a predefined format (e.g., image data, audio data, video data, text data, etc.), as indicated in block 366. Further, the compute device 110 may exclude user data associated with a location defined in the analysis exclusion data (e.g., a country, a state, a zip code, a street address, a set of boundaries defined by a set of geographic coordinates, etc.), as indicated in block 368. Additionally or alternatively, the compute device 110 may exclude user data that includes one or more tags defined in the analysis exclusion data (e.g., tags that include the user's name), as indicated in block 370. The method 300 continues in block 372 of FIG. 5, in which the compute device 110 may receive a request to selectively exclude, from future analysis, certain user data provided by the user (e.g., the user of the client compute device 120).

Referring now to FIG. 5, in receiving the request to selectively exclude user data, the compute device 110 may receive a request that includes analysis exclusion data that defines criteria of user data to be excluded from future analysis, as indicated in block 374. In doing so, the compute device 110 may receive a request that identifies user signature data (e.g., the public key of the user), as indicated in block 376. As indicated in block 378, the compute device 110 may receive a request that identifies a time period (e.g., a time before which all data is to be excluded, a time after which all data is to be excluded, a time period within which all data is to be excluded, etc.). Additionally or alternatively, the compute device 110 may receive a request that identifies location data (e.g., a country, a state, a zip code, a street address, a set of boundaries defined by a set of geographic coordinates, etc.) in the analysis exclusion data, as indicated in block 380. Further, the compute device 110 may receive a request that identifies a content format (e.g., image, audio, video, text, etc.) in the analysis exclusion data, as indicated in block 382. Similarly, the compute device 110 may receive a request that identifies one or more tags in the analysis exclusion data (e.g., for the compute device 110 to exclude, from future machine learning operations, user data having the specified tag(s)), as indicated in block 384.

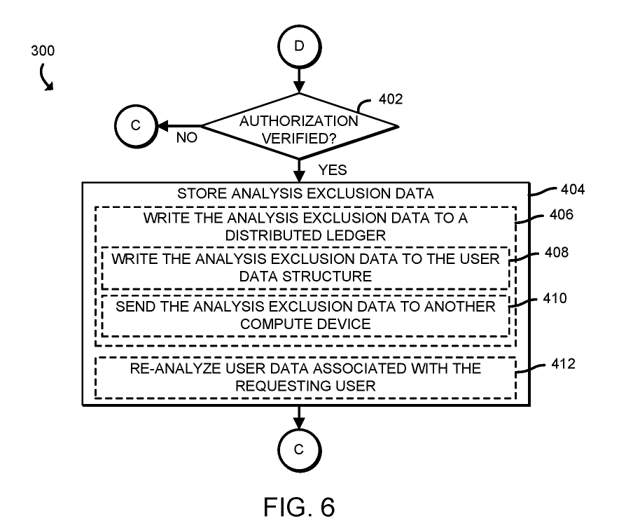

In block 386, the compute device 110 determines the subsequent course of action as a function of whether a request to selectively exclude data was received. If not, the method 300 loops back to block 302, in which the compute device 110 determines whether to continue enabling selective exclusion of user data. Otherwise, the method 300 advances to block 388, in which the compute device 110 verifies the requesting user's authorization have the user data excluded from future machine learning operations. In doing so, the compute device 110 verifies whether the requesting user is the owner of the user data to be excluded (e.g., the user who originally provided the user data to the compute device 110), as indicated in block 390. In doing so, the compute device 110 may verify that the requesting user has a private key associated with the user signature that is associated with the user data that is to be excluded, as indicated in block 392. In the illustrative embodiment, the compute device 110 may perform a challenge and response process to verify that the requesting user is the owner of the user data to be excluded (e.g., that the requesting user has the corresponding private key), as indicated in block 394. In doing so, the compute device 110 may send, to the client compute device 120, test data that is encrypted with the public key associated with the user (e.g., the public key provided in block 374), as indicated in block 396. Subsequently, the compute device 110 receives, from the client compute device 120, a set of responsive data (e.g., data sent in response to the test data), as indicated in block 398. If the requesting user has the private key, then the requesting user is able to decrypt the test data using the private key. In block 400, the compute device 110 determines whether the responsive data matches an unencrypted form of the test data. If so, the compute device 110 may determine that the requesting user is the owner of the user data that is to be excluded. Subsequently, the method 300 advances to block 402 of FIG. 6, in which the compute device 110 determines the subsequent course of action as a function of whether the authorization (e.g., the authorization of the requesting user to have the user data excluded) was verified.

Referring now to FIG. 6, in response to a determination that the authorization was not verified, the method 300 loops back to block 302, in which the compute device 110 determines whether to continue to enable selective exclusion of user data. Otherwise, the method 300 advances to block 404 in which the compute device 110 stores the analysis exclusion data (e.g., for use in future analysis of the user data). In doing so, the compute device 110 may write the analysis exclusion data to a distributed ledger, as indicated in block 406. For example, and as indicated in block 408, the compute device 110 may write the analysis exclusion data as an entry in the user data structure 160. The compute device 110 may also send the analysis exclusion data to another compute device, such as the compute device 112 (e.g., to store a copy of the analysis exclusion data), as indicated in block 410. Further, and as indicated in block 412, the compute device 110 may re-analyze the user data associated with the requesting user (e.g., this time ignoring the user data that satisfies the criteria specified in the analysis exclusion data). Regardless, after storing the analysis exclusion data, the method 300 loops back to block 302 to determine whether to continue to enable selective exclusion of user data. While the blocks of the method 300 are shown and described in a particular order for illustrative purposes, it should be understood that the operations associated with the blocks could be performed in a different order or concurrently (e.g., receiving new user data while concurrently analyzing existing user data, and/or while concurrently receiving a request to exclude certain user data from analysis).

### EXAMPLES

Illustrative examples of the technologies disclosed herein are provided below. An embodiment of the technologies may include any one or more, and any combination of, the examples described below.

Example 1 includes a compute device comprising circuitry to receive user data that defines content associated with a user; write the user data as one or more immutable entries in a data structure; receive a request to selectively exclude, from an analysis of the user data in the data structure, a portion of the user data that meets a set of criteria; and analyze the user data in the data structure while excluding, from the analysis, user data that satisfies the set of criteria.

Example 2 includes the subject matter of Example 1, and wherein to analyze the user data comprises to perform one or more machine learning operations on the user data.

Example 3 includes the subject matter of any of Examples 1 and 2, and wherein to perform one or more machine learning operations on the user data comprises to determine an interest of the user or predict an action of the user.

Example 4 includes the subject matter of any of Examples 1-3, and wherein the circuitry is further to determine whether a user associated with the request has authorization to request that the portion of the user data be selectively excluded and wherein to analyze the user data while excluding the user data that satisfies the set of criteria comprises to analyze, in response to a determination that the user has authorization, the user data while excluding the user data that satisfies the set of criteria.

Example 5 includes the subject matter of any of Examples 1-4, and wherein to write the user data in a data structure comprises to write the user data to a distributed ledger.

Example 6 includes the subject matter of any of Examples 1-5, and wherein to write the user data to a distributed ledger comprises to write the user data to a blockchain.

Example 7 includes the subject matter of any of Examples 1-6, and wherein to receive the request comprises to receive a request to exclude a portion of the user data associated with signature data of the user.

Example 8 includes the subject matter of any of Examples 1-7, and wherein to receive the request comprises to receive a request to exclude a portion of the user data that is additionally associated with a defined time period.

Example 9 includes the subject matter of any of Examples 1-8, and wherein to receive the request comprises to receive a request to exclude a portion of the user data is additionally associated with a defined geographic location.

Example 10 includes the subject matter of any of Examples 1-9, and wherein to receive the request comprises to receive a request to exclude a portion of the user data that is additionally associated with a tag that identifies the user.

Example 11 includes the subject matter of any of Examples 1-10, and wherein to receive the request comprises to receive a request to exclude a portion of the user data that is additionally associated with a content format.

Example 12 includes the subject matter of any of Examples 1-11, and wherein the circuitry is further to write the analysis exclusion data to a distributed ledger.

Example 13 includes the subject matter of any of Examples 1-12, and wherein the circuitry is further to write the analysis exclusion data to the data structure.

Example 14 includes the subject matter of any of Examples 1-13, and wherein the circuitry is further to send the analysis exclusion data to another compute device.

Example 15 includes one or more machine-readable storage media comprising a plurality of instructions stored thereon that, in response to being executed, cause a compute device to receive user data that defines content associated with a user; write the user data as one or more immutable entries in a data structure; receive a request to selectively exclude, from an analysis of the user data in the data structure, a portion of the user data that meets a set of criteria; and analyze the user data in the data structure while excluding, from the analysis, user data that satisfies the set of criteria.

Example 16 includes the subject matter of Example 15, and wherein to analyze the user data comprises to perform one or more machine learning operations on the user data.

Example 17 includes the subject matter of any of Examples 15 and 16, and wherein the plurality of instructions further cause the compute device to determine whether a user associated with the request has authorization to request that the portion of the user data be selectively excluded and wherein to analyze the user data while excluding the user data that satisfies the set of criteria comprises to analyze, in response to a determination that the user has authorization, the user data while excluding the user data that satisfies the set of criteria.

Example 18 includes the subject matter of any of Examples 15-17, and wherein to write the user data in a data structure comprises to write the user data to a distributed ledger.

Example 19 includes the subject matter of any of Examples 15-18, and wherein to write the user data to a distributed ledger comprises to write the user data to a blockchain.

Example 20 includes a method comprising receiving, by a compute device, user data that defines content associated with a user; writing, by the compute device, the user data as one or more immutable entries in a data structure; receiving, by the compute device, a request to selectively exclude, from an analysis of the user data in the data structure, a portion of the user data that meets a set of criteria; and analyzing, by the compute device, the user data in the data structure while excluding, from the analysis, user data that satisfies the set of criteria.

1. A compute device comprising:
circuitry to:
receive user data that defines content associated with a user;
write the user data as one or more immutable entries in a data structure;
receive a request to selectively exclude, from an analysis of the user data in the data structure, a portion of the user data that meets a set of criteria; and
analyze the user data in the data structure while excluding, from the analysis, user data that satisfies the set of criteria.

2. The apparatus of claim 1, wherein to analyze the user data comprises to perform one or more machine learning operations on the user data.

3. The apparatus of claim 2, wherein to perform one or more machine learning operations on the user data comprises to determine an interest of the user or predict an action of the user.

4. The apparatus of claim 1, wherein the circuitry is further to determine whether a user associated with the request has authorization to request that the portion of the user data be selectively excluded and wherein to analyze the user data while excluding the user data that satisfies the set of criteria comprises to analyze, in response to a determination that the user has authorization, the user data while excluding the user data that satisfies the set of criteria.

5. The apparatus of claim 1, wherein to write the user data in a data structure comprises to write the user data to a distributed ledger.

6. The apparatus of claim 5, wherein to write the user data to a distributed ledger comprises to write the user data to a blockchain.

7. The apparatus of claim 1, wherein to receive the request comprises to receive a request to exclude a portion of the user data associated with signature data of the user.

8. The apparatus of claim 7, wherein to receive the request comprises to receive a request to exclude a portion of the user data that is additionally associated with a defined time period.

9. The apparatus of claim 7, wherein to receive the request comprises to receive a request to exclude a portion of the user data is additionally associated with a defined geographic location.

10. The apparatus of claim 7, wherein to receive the request comprises to receive a request to exclude a portion of the user data that is additionally associated with a tag that identifies the user.

11. The apparatus of claim 7, wherein to receive the request comprises to receive a request to exclude a portion of the user data that is additionally associated with a content format.

12. The apparatus of claim 7, wherein the circuitry is further to write the analysis exclusion data to a distributed ledger.

13. The apparatus of claim 7, wherein the circuitry is further to write the analysis exclusion data to the data structure.

14. The apparatus of claim 7, wherein the circuitry is further to send the analysis exclusion data to another compute device.

15. One or more machine-readable storage media comprising a plurality of instructions stored thereon that, in response to being executed, cause a compute device to:
receive user data that defines content associated with a user;
write the user data as one or more immutable entries in a data structure;
receive a request to selectively exclude, from an analysis of the user data in the data structure, a portion of the user data that meets a set of criteria; and
analyze the user data in the data structure while excluding, from the analysis, user data that satisfies the set of criteria.

16. The one or more machine-readable storage media of claim 15, wherein to analyze the user data comprises to perform one or more machine learning operations on the user data.

17. The one or more machine-readable storage media of claim 15, wherein the plurality of instructions further cause the compute device to determine whether a user associated with the request has authorization to request that the portion of the user data be selectively excluded and wherein to analyze the user data while excluding the user data that satisfies the set of criteria comprises to analyze, in response to a determination that the user has authorization, the user data while excluding the user data that satisfies the set of criteria.

18. The one or more machine-readable storage media of claim 15, wherein to write the user data in a data structure comprises to write the user data to a distributed ledger.

19. The one or more machine-readable storage media of claim 18, wherein to write the user data to a distributed ledger comprises to write the user data to a blockchain.

20. A method comprising:
receiving, by a compute device, user data that defines content associated with a user;
writing, by the compute device, the user data as one or more immutable entries in a data structure;
receiving, by the compute device, a request to selectively exclude, from an analysis of the user data in the data structure, a portion of the user data that meets a set of criteria; and
analyzing, by the compute device, the user data in the data structure while excluding, from the analysis, user data that satisfies the set of criteria.
